(19) United States
(12) Patent Application Publication
(10) Pub. No.: US 2016/0034929 A1
(43) Pub. Date: Feb. 4, 2016

(54) Computerized Method for Extrapolating Customer Sentiment

(71) Applicant: FMR LLC, Boston, MA (US)

(72) Inventors: Andrew John McLellan, Cumberland, RI (US); Srinivasa R. Vagwala, S. Grafton, MA (US); Stein Erik Eriksen, Jefferson, MA (US); Rohith Kottamangalam Ashok, Medway, MA (US); Lilian Lee Wah Fette, Keller, TX (US)

(21) Appl. No.: 14/448,340

(22) Filed: Jul. 31, 2014

(51) Int. Cl. G06Q 30/02

(52) U.S. Cl. CPC G06Q 30/0203

(57) ABSTRACT

Method and systems are provided to extrapolate customer sentiment from interactions that customers have with an organization. Customer interaction data can include performance indication data, customer interface data, status of accounts data, and/or customer survey data. For each customer an overall sentiment score is determined. The overall sentiment score can be based on a positive or negative score that is determined for each data item within the customer interaction data.

### FIELD OF THE INVENTION

The invention relates generally to computer-based methods for extrapolating customer sentiment. More specifically, the invention relates to extrapolating customer sentiment based on interactions between a customer and an organization.

### BACKGROUND

Customer sentiment is obtained in a variety of contexts for a variety of types of sentiments. For example, a credit card company can analyze the purchases of a customer to decide which incentives to offer the customer. In another example, an organization can determine the customer's satisfaction based on customer surveys. In another example, an organization can determine the customer's satisfaction through direct interaction from relationship managers and sales managers.

Some organizations can find it difficult to determine whether a customer is satisfied with their services. For example, for a company that offers financial services products, determining whether the customer is satisfied with the service can be challenge. One method for determining whether the customer is satisfied is implementing customer surveys. However, customer surveys are sometimes not fully indicative of the overall experience of a customer, and are typically filled out to infrequently to allow for a periodic assessment. Another method is to gather customer satisfaction through relationship managers and sales managers. However, a strong business relationship can mask problems that can be exposed when the parties in the relationship change.

Therefore, it is desirable to extrapolate customer sentiment from a reliable information source.

### SUMMARY OF THE INVENTION

One advantage of the claimed invention includes enabling extrapolation customer sentiment data from interactions that the customer typically has with an organization, thus eliminating the need for the customer to execute additional steps to obtain the sentiment. Another advantage of the invention is that extrapolating customer sentiment removes human emotion that influences survey data and personal interaction data.

In one aspect, the invention involves computerized-method for extrapolating customer sentiment within an organization. The computerized-method involves receiving for a customer, customer interaction data, the customer interaction data comprising performance indication data, customer interface data, status of accounts data, and customer survey comment data. The method involves determining, by the computing device, a positive or negative score for each data item within the performance indication data, the customer interface data, the status of accounts data, and each survey comment data. The method also involves determining, by the computing device, an overall score for sentiment of the customer based on each of the positive and negative scores determined for each data item. The method also involves transmitting, by the computing device, the overall score for the customer to a display.

In some embodiments, the performance indication data comprises a new account score and a transfer of assets score. In some embodiments, the new account score is based on a classification of the customer, a minimum number of new accounts created within the organization over a time duration for all customers of the organization having the classification of the customer, a maximum number of new accounts created within the organization over the time duration for all customers of the organization having the classification of the customer, a number of new accounts created by the customer over the time duration, or any combination thereof.

In some embodiments, the transfer of assets score is based on a classification of the customer, a minimum and a maximum of a change in percent of transfer of assets over a time duration for all customers of the organization having the classification of the customer, a change in percent of transfer of assets for the customer over the time duration, or any combination thereof.

In some embodiments, the customer interface data comprises a customer email score, a customer phone call score, a customer service center score, or any combination thereof. In some embodiments, the customer email score is based on a classification of the customer, a minimum and a maximum of a sentiment value assigned to emails over a time duration for all customers of the organization having the classification of the customer.

In some embodiments, the customer phone call score is based on a classification of the customer and one or more attributes of phone call received within the organization. In some embodiments, the attributes of the one or more phone calls comprise a classification of the customer, a minimum number of phone calls received within the organization over a time duration for all customers of the organization having the classification of the customer, a maximum number of phone calls received within the organization over the time duration for all customers of the organization having the classification of the customer, a number of phone calls received by the customer over the time duration, a minimum call time duration for phone calls received within the organization over a time duration for all customers of the organization having the classification of the customer, a maximum call time duration for phone calls received within the organization over the time duration for all customers of the organization having the classification of the customer, an average call time duration for phone calls received by the customer over the time duration, or any combination thereof.

In some embodiments, the status of accounts data is based on a classification of the customer, a minimum and a maximum of a sentiment value assigned to emails over a time duration for all customers of the organization having the classification of the customer, the sentiment value being based on the emails.

In some embodiments, the survey comment data is based on a classification of the customer, a minimum and a maximum of a sentiment value assigned to emails over a time duration for all customers of the organization having the classification of the customer, the sentiment value being based on the survey comment data.

In some embodiments, the method also includes validating, by the computing device, the overall score for sentiment of the customer based a classification of the customer and on one or more previous overall scores of sentiment of all customers having the classification.

### BRIEF DESCRIPTION OF THE DRAWINGS

The foregoing and other objects, features, and advantages of the present invention, as well as the invention itself, will be more fully understood from the following description of various embodiments, when read together with the accompanying drawings.

FIG. 1 is a block diagram showing an exemplary computing system for extrapolating customer sentiment, according to an illustrative embodiment of the invention.

FIG. 2 is a block diagram showing an exemplary system for extrapolating customer sentiment, according to an illustrative embodiment of the invention.

FIG. 3 is a block diagram showing an exemplary method for extrapolating customer sentiment, according to an illustrative embodiment of the invention.

FIGS. 4A-4I are screen shots of exemplary interfaces for viewing customer sentiment, according to illustrative embodiments of the invention.

### DETAILED DESCRIPTION

Generally, for an organization that offers products and service to its customers, e.g., a financial organization, customer sentiment can be extrapolated from interactions that the customers have with the organization. Customer interaction data can include performance indication data, customer interface data, status of accounts data, and/or customer survey data. For each customer or product of a customer an overall sentiment score is determined. The overall sentiment score can be based on a positive or negative score that is determined for each data item within the customer interaction data. The overall sentiment score can be transmitted to a display.

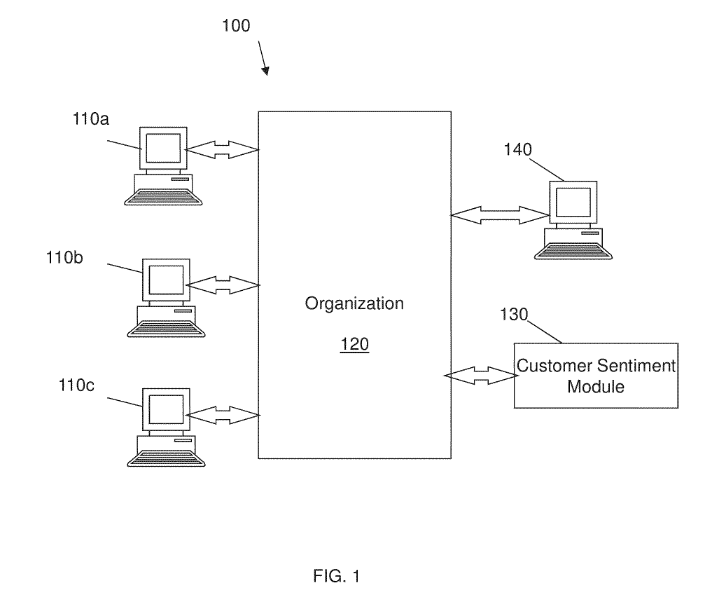

FIG. 1 is a block diagram showing an exemplary computing system 100 extrapolating customer sentiment, according to an illustrative embodiment of the invention. The computing system includes customer computer 110a, customer computer 110b, customer computer 110c. an organization's computing system 120, a customer sentiment module 130 and an organization's computer 140.

The customer computers 110a, 110b, and 110c are in communication with the organization's computing system 120. The organization's computing system 120 is in communication with the customer sentiment module 140 and the organization's computer 140.

During operation, one or more customers interact with the organization's computing system 120 via a respective customer computer 110a, 110b, and 110c. The customer sentiment module 140 monitors each of the customer's interactions and stores data related to the customer's interactions. The customer sentiment module 140 determines customer sentiment based on the customer's interactions. The customer sentiment module 140 displays the determined customer sentiment to the organization's computer 130.

It is apparent to one of ordinary skill in the art that the configuration of the computer system 100 is for exemplary purposes only, and that many different configurations are realized without departing from the scope of the invention. For example, there can be more or less customer computers, the customer sentiment module 140 can be part of the organization's computing system 120, the customer sentiment module 140 can be any number of computing devices, the customer sentiment module 140 can communicate with any of the customer computers 110a, 110b, and 110c, and/or the organization's computing system 120 can be more than one computing devices/systems.

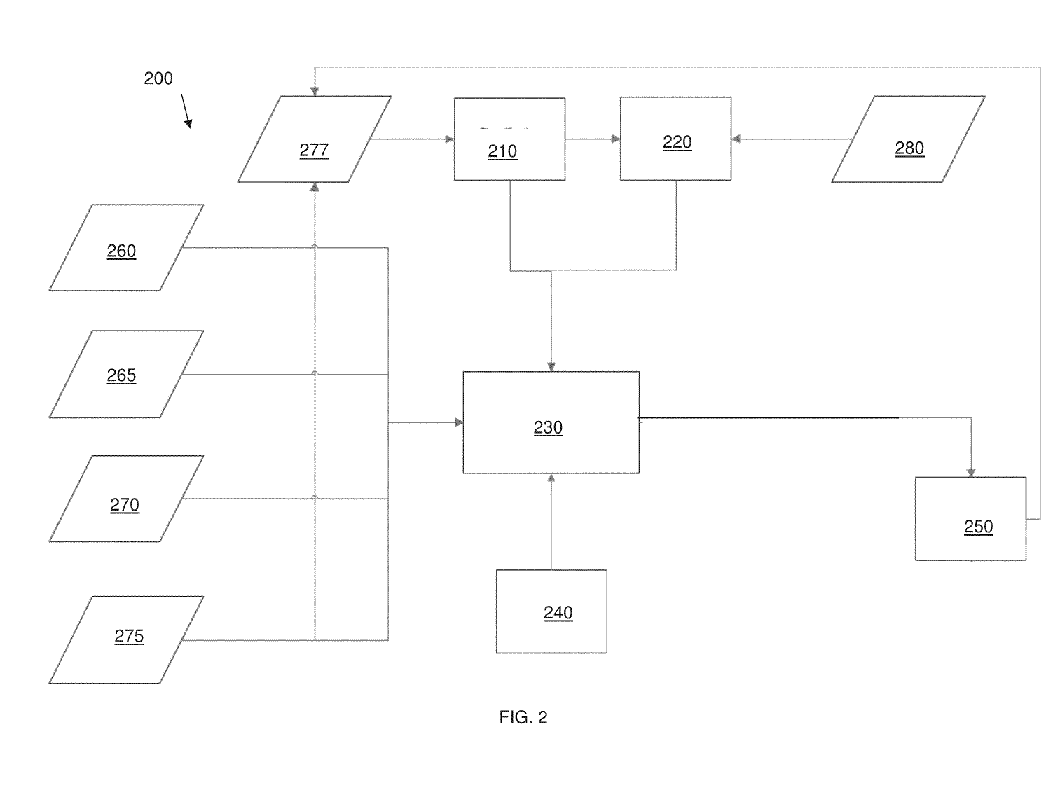

FIG. 2 is a block diagram showing an exemplary system 200 for extrapolating customer sentiment, according to an illustrative embodiment of the invention. The system 200 includes a classification model module 210, an unstructured sentiment module 220, a customer sentiment model module 230, a scoring model module 240, and a validation module 250.

The system 200 takes as input computer system log data 260, structured transaction data 265, structured interaction data 270, unstructured interaction data 275, training data 277 and a sentiment dictionary 280.

Computer system log data 260 can include data regarding the time is takes a customer's service request to be complete, accuracy of the customer's computing request, data input by a customer service center, performance data that can be tied directly to service level agreements and/or a normalized user experience, error data regarding errors in the log, or any combination thereof.

Structured transaction data 265 can include number of new accounts created by a customer, transfer of assets (volume or amount) into and out of the organization, cashiering, or any combination thereof.

Structured interaction data 270 can include errors of an organization during transactions with the customer, number of the customer's accounts that are not in good order, number of new accounts opened by the customer, number of accounts closed by the customer, number of phone calls transmitted to and/or received from the customer, wait time of phone calls from the customer, need to recover service to the customer, a rate at which the customer adopts new tools offered by the organization, amount of maintenance needed on the customer's accounts, number of errors made to the customer's accounts by the organization, or any combination thereof.

Unstructured interaction data 275 can include data from the customer's social media, email from the customer, notes from management regarding the customer, survey comments, or any combination thereof.

The sentiment dictionary 280 can include phrases that are likely used that indicate sentiment. For example, “I am having a problem” or “I'm leaving a platform.” In some embodiments, dictionary terms include “NIGOS, NIGO. Error, Transfer of Assets, Delivery, New Account, Account Maintenance, Disappointed, Confused, Not Corrected, Please Correct and/or Issue” Other phrases can be included in the sentiment dictionary as is apparent to one of ordinary skill in the art.

The training data 255 can include all sentiment scores provided by customers via a customer survey and/or interaction as described above. The interactions can be measured against the sentiment score to determine the relationship between the between the interaction and the sentiment score.

The classification model module 210 takes as input the training data 277. The classification module 210 determines a classification for the customer. The customer can be classified based on volume of transactions, interactions, and/or expected level of service. The classification module 210 outputs the classification to the unstructured sentiment module 220 and the customer sentiment model module 230.

The scoring module 240 takes as input the training data 277. The scoring module 240 determines a score for the training data 277 based on previous and current training data 277.

The unstructured sentiment module 220 determines an unstructured sentiment score for unstructured interaction data 275 based on the classification and the sentiment dictionary 280. In some embodiments, the unstructured sentiment score is determined based on natural language processing algorithms (e.g., open source natural language processing algorithms or Apache Mahout), as is apparent to one of ordinary skill in the art. The unstructured sentiment module 220 outputs the unstructured sentiment score to the customer sentiment model module 230.

The customer sentiment model module 230 receives the classification, the unstructured sentiment score, the score for the training data, the computer system log data 260, the structured transaction data 265, the structured interaction data 270, and/or the unstructured interaction data 275. The customer sentiment model module 230 determines an overall sentiment score for a given customer.

The overall sentiment score is validated by the validation module 250. The validation module 250 is compared against a sentiment score tolerance. The sentiment score tolerance can be input by a user. If the overall sentiment score is within the sentiment score tolerance, then the overall sentiment score used as a basis to train new input at a specified point in time.

In some embodiments, the overall sentiment score indicates sentiment for a product of the customer. In some embodiments, the overall sentiment score indicates sentiment for a company.

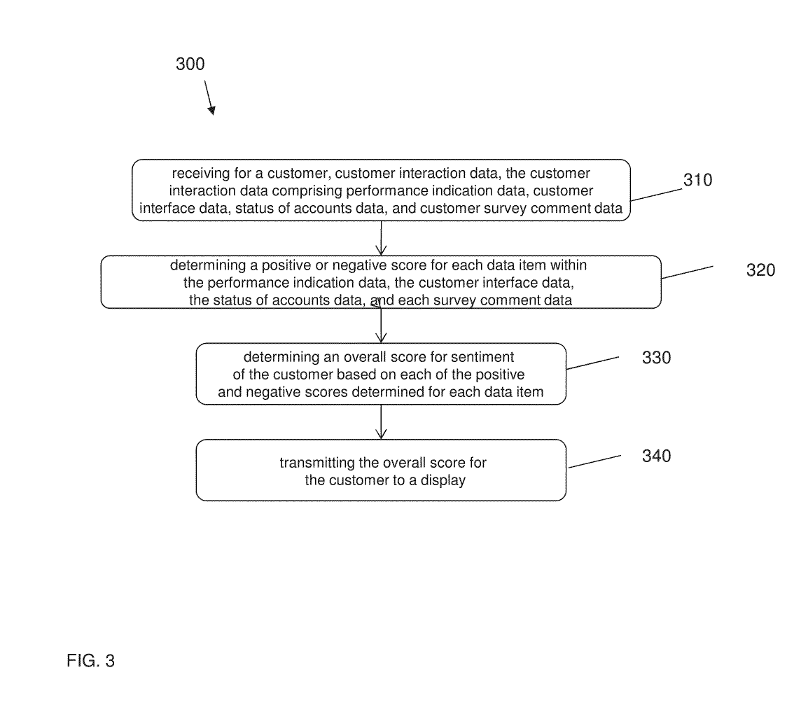

FIG. 3 is a block diagram showing an exemplary method 300 for extrapolating customer sentiment, according to an illustrative embodiment of the invention. The method involves receiving customer interaction data for a given customer (e.g., customer interaction data # as described above in FIG. 2) (Step 310). The customer interaction data can include performance indication data, customer interface data, status of accounts data, and customer survey comment data.

The method also involves determining a positive or negative score for each data item within the performance indication data, the customer interface data, the status of accounts data, and each survey comment data (Step 320).

In some embodiments, the performance indication data includes a new account score and a transfer of assets score. In some embodiments, the new account score is determined as follows:

$$\frac{\# of new accounts - min \# of new accounts}{( max \# of new accounts - min \# of new accouts ) / 5} + 1 \qquad EQN . 1$$

where # of new accounts is the number of new accounts for the customer over a time duration (e.g., one day, one week, one month, one year, multiple years), min # of new accounts is the minimum number of new accounts opened during the time duration for all customers of the organization having the same classification as the customer, and max # of new accounts is the maximum number of new accounts opened during the time duration for all customers of the organization having the same classification as the customer.

The new account score can be assigned a value between 1 and 5. Determining a maximum number of new accounts and a minimum number of new accounts for all customers within the organization can include determining a number of new accounts for all customers within the organization having the classification of the customer. The range of resulting values can be portioned into five ranges, and each range can be assigned a value between 1 and 5. The new account score as determined above with EQN. 1 can be assigned a value between 1 and 5 that corresponds to the value for the range that the new account score falls within.

In various embodiments, the min # of new accounts and/or the max # of new accounts is determined for all customers of the organization independent of classification. It is apparent to one of ordinary skill that the given time duration can be any time duration that is desired to determine customer sentiment within.

In various embodiments, the transfer of assets score includes a positive transfer of assets score percent change (positive TOA) and/or a negative transfer of assets score percent change (negative TOA).

In some embodiments, the positive transfer of assets score percent change (positive TOA) is determined as follows:

$$\frac{value of positive TOA \% change}{max positive TOA \% change / 5} \qquad EQN . 2$$

where value of positive TOA % change is the percent change in the transfer of assets into the organization for the customer over the time duration and the max positive TOA % is the maximum of the positive percent change in the transfer of assets into the organization for all customers over the time duration.

The positive transfer of assets score percent change (positive TOA) can be assigned a value between 1 and 5. Determining a maximum positive number of TOA % change can include determining positive TOA % change for all customers within the organization having the classification of the customer. The range of resulting values can be portioned into five ranges, and each range can be assigned a value between 1 and 5. The positive transfer of assets score percent change (positive TOA) as determined above with EQN. 2 can be assigned a value between 1 and 5 that corresponds to the value for the range that the positive transfer of assets score percent change (positive TOA) falls within.

In some embodiments, the negative transfer of assets score percent change (negative TOA) is determined as follows:

$$\frac{value of negative TOA \% change}{max negative TOA \% change / 5} \qquad EQN . 3$$

where value of negative TOA % change is the percent change in the transfer of assets out the organization for the customer over the time duration and the max negative TOA % is the maximum of the negative percent change in the transfer of assets into the organization for all customers over the time duration.

The negative transfer of assets score percent change (negative TOA) can be assigned a value between 1 and 5. Determining a maximum negative number of TOA % change can include determining negative TOA % change for all customers within the organization having the classification of the customer. The range of resulting values can be portioned into five ranges, and each range can be assigned a value between 1 and 5. The negative transfer of assets score percent change (negative TOA), for example as determined above with EQN. 3, can be assigned a value between 1 and 5 that corresponds to the value for the range that the negative transfer of assets score percent change (negative TOA) falls within.

In some embodiments, positive TOA % change is determined as follows:

$$\frac{Net TOA in End - Net TOA in Start}{Net TOA in End * 100} \qquad EQN . 4$$

where Net TOA in End is the net transfer of assets into the organization at the end of the time duration and Net TOA in Start is the net transfer of assets into the organization at the start of the time duration.

In some embodiments, negative TOA % change is determined as follows:

$$\frac{Net TOA out End - Net TOA out Start}{Net TOA out End * 100} \qquad EQN . 5$$

where Net TOA out End is the net transfer of assets out of the organization at the end of the time duration and Net TOA out Start is the net transfer of assets out of the organization at the start of the time duration.

In some embodiments, the customer interface data includes a customer email score, a customer phone call score, a number of service center inquiries score, or any combination thereof.

In some embodiments, the customer email score is based on unstructured data (e.g., email). The customer email score can be based on a classification of the customer, a minimum and a maximum of a sentiment value assigned to emails over a time duration for all customers of the organization having the classification of the customer. In some embodiments, the customer email score can include a positive customer email score and a negative customer email score.

In some embodiments, the positive customer email score can be determined as follows:

$$\frac{email positive sentiment value}{max email positive sentiment value / 5} \qquad EQN . 6$$

where email positive sentiment value is determined based on natural language processing algorithms, as is apparent to one of ordinary skill in the art. In various embodiments, the positive sentiment value ranges from zero to ten. The max email positive sentiment value is the maximum of all positive email sentiment values. In some embodiments, the positive customer email score can be rounded to the next nearest integer.

The positive customer email score can be assigned a value between 1 and 5. Determining a maximum max email positive sentiment value can include determining an email positive sentiment value change for all customers within the organization having the classification of the customer. The range of resulting values can be portioned into five ranges, and each range can be assigned a value between 1 and 5. The positive customer email score, for example as determined above with EQN. 6, can be assigned a value between 1 and 5 that corresponds to the value for the range that the positive customer email score falls within.

In some embodiments, the negative customer email score can be determined as follows:

$$\frac{email negative sentiment value}{max email negative sentiment value / 5} \qquad EQN . 7$$

where email negative sentiment value is determined based on natural language processing algorithms, as is apparent to one of ordinary skill in the art. In various embodiments, the negative sentiment value ranges from zero to ten. The max email negative sentiment value is the maximum of all negative email sentiment values. In some embodiments, the negative customer email score can be rounded to the next nearest integer.

The negative customer email score can be assigned a value between 1 and 5. Determining a maximum max email negative sentiment value can include determining an email negative sentiment value change for all customers within the organization having the classification of the customer. The range of resulting values can be portioned into five ranges, and each range can be assigned a value between 1 and 5. The negative customer email score, for example as determined above with EQN. 7, can be assigned a value between 1 and 5 that corresponds to the value for the range that the negative customer email score falls within.

In some embodiments, the customer phone call score is based on a classification of the customer and one or more attributes of phone call received within the organization. The customer phone call score can be based on a number of phone calls score. In some embodiments, the number of phone calls score is determined as follows:

$$\frac{\# of phone calls - min \# of phone calls}{( max \# of phone calls - min \# phone calls ) / 5} + 1 \qquad EQN . 7$$

where # of number of phone calls is the number of phone calls received from the customer over the time duration, min # of phone calls is the minimum number of phone calls received, over the time duration, by all customers of the organization having the same classification as the customer, and max # of phone calls is the maximum number of phone calls received, over the time duration, for all customers of the organization having the same classification as the customer.

The number of phone calls score can be assigned a value between 1 and 5. Determining a maximum number of phone calls and a minimum number of phone calls received by all customers within the organization can include determining a number of phone calls for all customers within the organization having the classification of the customer. The range of resulting values can be portioned into five ranges, and each range can be assigned a value between 1 and 5. The number of phone calls score as determined above with EQN. 7 can be assigned a value between 1 and 5 that corresponds to the value for the range that the number of phone calls score falls within.

The customer phone call score can be based on a duration of phone calls score. In some embodiments, the duration of phone calls score is determined as follows:

$$\frac{\begin{matrix}duration of phone calls - \\ min duration of phone calls\end{matrix}}{( \begin{matrix}max duration of phone calls - \\ min duration of phone calls\end{matrix} ) / 5} + 1 \qquad EQN . 8$$

where duration of number of phone calls is the duration of phone calls received from the customer over the time duration, min duration of phone calls is the minimum number of phone calls received, over the time duration, by all customers of the organization having the same classification as the customer, and max duration of phone calls is the maximum number of phone calls received, over the time duration, for all customers of the organization having the same classification as the customer.

The duration of phone calls score can be assigned a value between 1 and 5. Determining a maximum number of phone calls and a minimum number of phone calls received by all customers within the organization can include determining a number of phone calls for all customers within the organization having the classification of the customer. The range of resulting values can be portioned into five ranges, and each range can be assigned a value between 1 and 5. The number of phone calls score as determined above with EQN. 8 can be assigned a value between 1 and 5 that corresponds to the value for the range that the number of phone calls score falls within.

In some embodiments, the number of service center inquiries score is based on classification of the customer, number of service center inquires by the customer over the time duration, a minimum and a maximum, number of service center inquires over the time duration for all customers of the organization having the classification of the customer.

The number of service center inquiries score can be based on any type of service center inquiry made (e.g., email, phone call and/or letter). In some embodiments, the number of service center inquiries score is determined as follows:

$$\frac{\# service inquires - min service inquires}{( max \# service inquires - min \# service inquires ) / 5} + 1 \qquad EQN . 9$$

where # service inquires is the number of service center inquires by the customer over the time duration, min # service inquires is the minimum number of number of service center inquires, over the time duration, for all customers of the organization having the same classification as the customer, and max service inquires is the maximum number of number of service center inquires, over the time duration, for all customers of the organization having the same classification as the customer.

The service center inquires score can be assigned a value between 1 and 5. Determining a maximum number of service center inquires score and a minimum number of accounts service center inquires score for all customers within the organization can include determining a service center inquires score for all customers within the organization having the classification of the customer. The range of resulting values can be portioned into five ranges, and each range can be assigned a value between 1 and 5. The service center inquires score as determined above with EQN. 9 can be assigned a value between 1 and 5 that corresponds to the value for the range that the service center inquires score falls within.

In some embodiments, the status of accounts data is based a number of accounts in good order for the customer score and/or a number of quality errors for the customer score.

In some embodiments, the number of accounts in good order score is based on classification of the customer, number of accounts that are in good order for the customer over the time duration, a minimum and a maximum number of accounts that are not in good order over the time duration for all customers of the organization having the classification of the customer.

The number of accounts not in good order (NIGO) score can be based on whether all information required by the customer of the account is provided and recorded properly. For example, an account can move into NIGO status if it requires beneficiary information and that information has not been provided. In some embodiments, the number of accounts not in good order (NIGO) score is determined as follows:

$$\frac{\# accts NIGO - min \# accts NIGO}{( max \# accts NIGO - min \# accts NIGO ) / 5} + 1 \qquad EQN . 10$$

where # accts NIGO is the number of accounts not in good order of the customer over the time duration, min # accts NIGO is the minimum number of number of accounts not in good order, over the time duration, for all customers of the organization having the same classification as the customer, and max # accts NIGO is the maximum number of number of accounts not in good order, over the time duration, for all customers of the organization having the same classification as the customer.

The number of accounts not in good order (NIGO) score can be assigned a value between 1 and 5. Determining a maximum number of accounts in good order (NIGO) and a minimum number of accounts in good order (NIGO) for all customers within the organization can include determining a number of accounts not in good order (NIGO) for all customers within the organization having the classification of the customer. The range of resulting values can be portioned into five ranges, and each range can be assigned a value between 1 and 5. The number of accounts not in good order (NIGO) score as determined above with EQN. 10 can be assigned a value between 1 and 5 that corresponds to the value for the range that the number of phone calls score falls within.

In some embodiments, the quality error score is based on classification of the customer, number of quality errors by the customer over the time duration, a minimum and a maximum number of quality errors over the time duration for all customers of the organization having the classification of the customer.

The quality error score can be based on whether an transaction or interaction fails, and/or an account moves into NIGO status. In some embodiments, the quality error score is determined as follows:

$$\frac{\# quality errors - min quality error}{( max \# quality error - min \# quality error ) / 5} + 1 \qquad EQN . 11$$

where # quality errors is the number of quality errors for the customer over the time duration, min # service inquires is the minimum number of quality errors, over the time duration, for all customers of the organization having the same classification as the customer, and max number of quality errors is the maximum number of number of number of quality errors, over the time duration, for all customers of the organization having the same classification as the customer.

The quality error score can be assigned a value between 1 and 5. Determining a maximum number of number of quality errors and a minimum number of number of quality errors for all customers within the organization can include determining a number of quality errors score for all customers within the organization having the classification of the customer. The range of resulting values can be portioned into five ranges, and each range can be assigned a value between 1 and 5. The quality errors score as determined above with EQN. 11 can be assigned a value between 1 and 5 that corresponds to the value for the range that the number of quality errors score falls within.

In some embodiments, the survey comment data score is based on unstructured data (e.g., email). In some embodiments, the survey comment data score can be determined as follows:

$$\frac{survey positive sentiment value}{max survey positive sentiment value / 5} \qquad EQN . 12$$

where survey positive sentiment value is based on a survey that includes questions that asks a customer questions that indicate sentiment. The max survey positive sentiment value is determined by finding the maximum value in the survey. In some embodiments, the survey comment data can be rounded to the next nearest integer.

The survey comment data score can be assigned a value between 1 and 5. Determining a maximum max survey positive sentiment value can include determining a survey positive sentiment value for all customers within the organization having the classification of the customer. The range of resulting values can be portioned into five ranges, and each range can be assigned a value between 1 and 5. The survey positive sentiment value score, for example as determined above with EQN. 12, can be assigned a value between 1 and 5 that corresponds to the value for the range that the positive survey comment score falls within.

In some embodiments, the negative survey comment score can be determined as follows:

$$\frac{survey negative sentiment value}{max survey negative sentiment value / 5} \qquad EQN . 13$$

where survey negative sentiment value is based on a survey that includes questions that asks a customer questions that indicate sentiment. The max survey negative sentiment value is determined by finding the maximum value in the survey. In some embodiments, the survey comment data can be rounded to the next nearest integer.

The negative survey comment score can be assigned a value between 1 and 5. Determining a maximum max survey negative sentiment value can include determining an survey negative sentiment value change for all customers within the organization having the classification of the customer. The range of resulting values can be portioned into five ranges, and each range can be assigned a value between 1 and 5. The negative survey comment score, for example as determined above with EQN. 7, can be assigned a value between 1 and 5 that corresponds to the value for the range that the negative survey comment score falls within.

In some embodiments, other types of unstructured data are assigned negative and positive sentiment scores for the customer and all customers having the same classification as the customer, over the time duration, in the same manner as provided by EQN. 12 and EQN. 13. For example, NPS, CEI, Activity Notes, Firm Notes, Firm Cases, or any combination thereof. The unstructured data can be any textual interaction between a company and its customers.

In some embodiments, the overall score for sentiment of the customer is validated based a sentiment score tolerance. The sentiment score tolerance can be input by a user. If the overall sentiment score is within the sentiment score tolerance, then the overall sentiment score used as a basis to train new input at a specified point in time.

The method also involves determining an overall score for sentiment of the customer based on each of the positive and negative scores determined for each data item (Step 330). In some embodiments, the overall sentiment score is determined by subtracting an average of all negative scores determined for each data time from an average of all positive scores determined for each data item.

The method also involves transmitting the overall score for the customer to a display (Step 340).

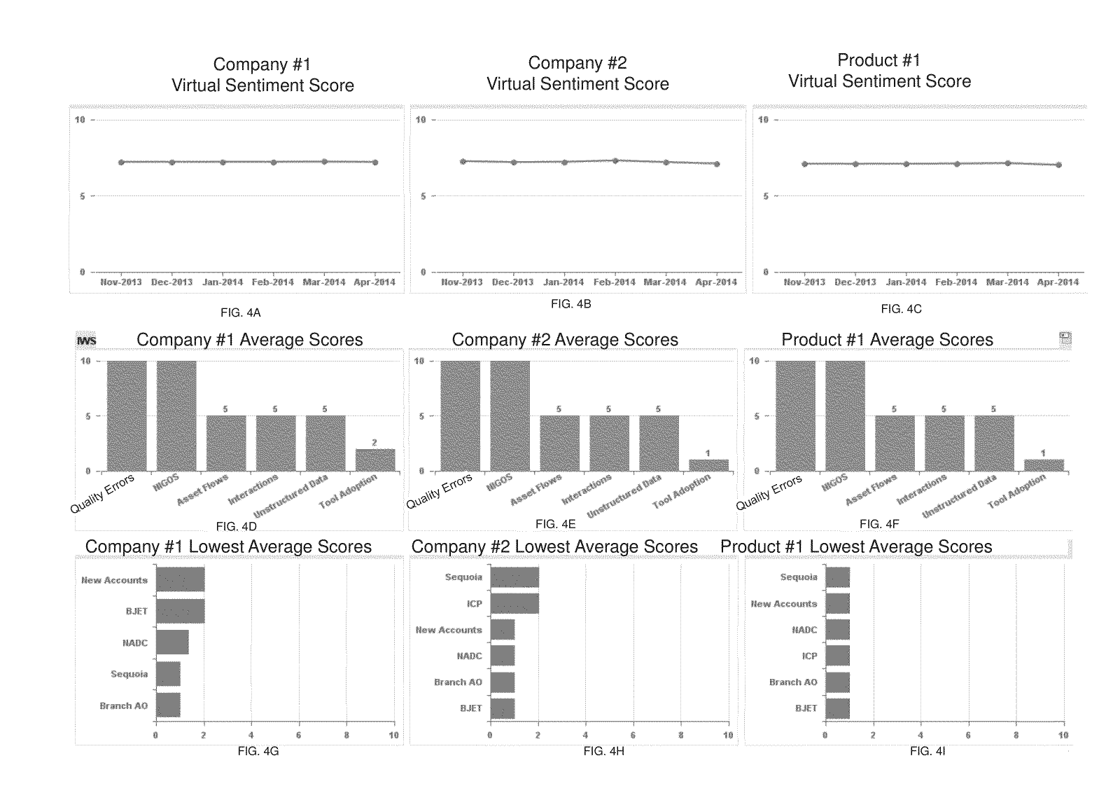

FIGS. 4A-4I are screen shots of exemplary interfaces for viewing customer sentiment, according to illustrative embodiments of the invention. FIG. 4A, FIG. 4B, and FIG. 4C show exemplary sentiment scores over a six months period for a first company, Company #1, a second company, Company #2, and a first product, Product #1. The first company, the second company, and the first product can all be associated with a single customer. The first product can be a product of the first company.

FIG. 4D, FIG. 4E, and FIG. 4F show exemplary average scores for values used to determine overall sentiment the first company, the second company, and the first product. FIG. 4G, FIG. 4H, and FIG. 4I show exemplary lowest average scores for values used to determine overall sentiment the first company, the second company, and the first product.

The above-described systems and methods can be implemented in digital electronic circuitry, in computer hardware, firmware, and/or software. The implementation can be as a computer program product (e.g., a computer program tangibly embodied in an information carrier). The implementation can, for example, be in a machine-readable storage device for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by an apparatus and can be implemented as special purpose logic circuitry. The circuitry can, for example, be a FPGA (field programmable gate array) and/or an ASIC (application-specific integrated circuit). Modules, subroutines, and software agents can refer to portions of the computer program, the processor, the special circuitry, software, and/or hardware that implement that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data (e.g., magnetic, magneto-optical disks, or optical disks).

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by, and/or incorporated in special purpose logic circuitry.

To provide for interaction with a user, the above described techniques can be implemented on a computer having a display device, a transmitting device, and/or a computing device. The display device can be, for example, a cathode ray tube (CRT) and/or a liquid crystal display (LCD) monitor. The interaction with a user can be, for example, a display of information to the user and a keyboard and a pointing device (e.g., a mouse or a trackball) by which the user can provide input to the computer (e.g., interact with a user interface element). Other kinds of devices can be used to provide for interaction with a user. Other devices can be, for example, feedback provided to the user in any form of sensory feedback (e.g., visual feedback, auditory feedback, or tactile feedback). Input from the user can be, for example, received in any form, including acoustic, speech, and/or tactile input.

The computing device can include, for example, a computer, a computer with a browser device, a telephone, an IP phone, a mobile device (e.g., cellular phone, personal digital assistant (PDA) device, laptop computer, electronic mail device), and/or other communication devices. The computing device can be, for example, one or more computer servers. The computer servers can be, for example, part of a server farm. The browser device includes, for example, a computer (e.g., desktop computer, laptop computer, and tablet) with a World Wide Web browser (e.g., Microsoft® Internet Explorer® available from Microsoft Corporation, Chrome available from Google, Mozilla® Firefox available from Mozilla Corporation, Safari available from Apple). The mobile computing device includes, for example, a personal digital assistant (PDA).

Website and/or web pages can be provided, for example, through a network (e.g., Internet) using a web server. The web server can be, for example, a computer with a server module (e.g., Microsoft® Internet Information Services available from Microsoft Corporation, Apache Web Server available from Apache Software Foundation, Apache Tomcat Web Server available from Apache Software Foundation).

The storage module can be, for example, a random access memory (RAM) module, a read only memory (ROM) module, a computer hard drive, a memory card (e.g., universal serial bus (USB) flash drive, a secure digital (SD) flash card), a floppy disk, and/or any other data storage device. Information stored on a storage module can be maintained, for example, in a database (e.g., relational database system, flat database system) and/or any other logical information storage mechanism.

The above-described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication (e.g., a communication network). Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

The above described networks can be implemented in a packet-based network, a circuit-based network, and/or a combination of a packet-based network and a circuit-based network. Packet-based networks can include, for example, the Internet, a carrier internet protocol (IP) network (e.g., local area network (LAN), wide area network (WAN), campus area network (CAN), metropolitan area network (MAN), home area network (HAN), a private IP network, an IP private branch exchange (IPBX), a wireless network (e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network (e.g., RAN, Bluetooth®, code-division multiple access (CDMA) network, time division multiple access (TDMA) network, global system for mobile communications (GSM) network), and/or other circuit-based networks.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A computerized-method for extrapolating customer sentiment within an organization based on, the method comprising:
receiving for a customer, by a computing device, customer interaction data, the customer interaction data comprising performance indication data, customer interface data, status of accounts data, and customer survey comment data;
determining, by the computing device, a positive score, a negative score, or both, for each data item within the performance indication data, the customer interface data, the status of accounts data, and each survey comment data;
determining, by the computing device, an overall score for sentiment of the customer based on each of the positive and negative scores determined for each data item; and
transmitting, by the computing device, the overall score for the customer to a display.

2. The computerized-method of claim 1, wherein the performance indication data comprises a new account score and a transfer of assets score.

3. The computerized-method of claim 2, wherein the new account score is based on a classification of the customer, a minimum number of new accounts created within the organization over a time duration for all customers of the organization having the classification of the customer, a maximum number of new accounts created within the organization over the time duration for all customers of the organization having the classification of the customer, a number of new accounts created by the customer over the time duration, or any combination thereof.

4. The computerized-method of claim 2, wherein the transfer of assets score is based on a classification of the customer, a minimum and a maximum of a change in percent of transfer of assets over a time duration for all customers of the organization having the classification of the customer, a change in percent of transfer of assets for the customer over the time duration, or any combination thereof.

5. The computerized-method of claim 1, wherein the customer interface data comprises a customer email score, a customer phone call score, a number of service center inquiries score, or any combination thereof.

6. The computerized-method of claim 5, wherein the customer email score is based on a classification of the customer, a minimum and a maximum of a sentiment value assigned to emails over a time duration for all customers of the organization having the classification of the customer.

7. The computerized-method of claim 5, wherein the customer phone call score is based on a classification of the customer and on ore more attributes of phone call received within the organization.

8. The computerized-method of claim 7, wherein the attributes of the one or more phone calls comprise a classification of the customer, a minimum number of phone calls received within the organization over a time duration for all customers of the organization having the classification of the customer, a maximum number of phone calls received within the organization over the time duration for all customers of the organization having the classification of the customer, a number phone calls received by the customer over the time duration, a minimum call time duration for phone calls received within the organization over a time duration for all customers of the organization having the classification of the customer, a maximum call time duration for phone calls received within the organization over the time duration for all customers of the organization having the classification of the customer, an average call time duration for phone calls received by the customer over the time duration, or any combination thereof.

9. The computerized-method of claim 1, wherein the status of accounts data is based on a classification of the customer, a number of accounts in good order for the customer, a number of quality errors for the customer, or any combination thereof.

10. The computerized-method of claim 1, wherein the survey comment data is based on a classification of the customer, a minimum and a maximum of a sentiment value assigned to emails over a time duration for all customers of the organization having the classification of the customer, the sentiment value being based on the survey comment data.

11. The computerized-method of claim 1, further comprising validating, by the computing device, the overall score for sentiment of the customer based a classification of the customer and on one or more previous overall scores of sentiment of all customers having the classification.
